(19) United States
(12) Patent Application Publication
(10) Pub. No.: US 2005/0171836 A1
(43) Pub. Date: Aug. 4, 2005

(54) Electronic commerce portal

(76) Inventor: Kenneth Robert Leacy, New South Wales (AU)

Correspondence Address: DLA PIPER RUDNICK GRAY CARY US, LLP, 4365 EXECUTIVE DRIVE, SUITE 1100, SAN DIEGO, CA, 92121-2133, US

(21) Appl. No.: 10/515,109

(22) PCT Filed: May 19, 2003
(86) PCT No.: PCT/AU03/00586

(30) Foreign Application Priority Data
May 20, 2002 (AU) PS2417

(51) Int. Cl. G06F 17/60

(52) U.S. Cl. 705/14

(57) ABSTRACT

An electronic commerce portal (36) for electronic commerce over the World Wide Web, the portal (36) comprising a portal web site (31) and a collection of merchant web sites (33) linked to thc portal (36), and merchant tools (21) to build and maintain merchant web sites (33); wherein the tools (21) include functionality to allow merchants to select products and services to be offered with an associated buyer incentive, and wherein the portal (36) operates to cause the buyer incentives to be displayed on the merchant web site (33) and on a page (40) of the postal web site (31) according to pre-determined portal rules.

### TECHNICAL FIELD

This invention concerns an electronic commerce portal for electronic commerce over the World Wide Web; also known as a “hub”. The invention also concerns an electronic commerce management software program. In a further aspect, the invention concerns e method of operating an electronic commerce portal.

### BACKGROUND TO THE INVENTION

E-commerce is generally understood to refer to the exchange of information across electronic networks. The information exchange may take place at any stage in the supply chain, whether within an organisation, between businesses, between businesses and consumers, or between the public and private sectors. The information exchange may involve payment or be unpaid. E-commerce uses electronic networks such as the Internet to simplify and speed up all stages of the business process, from design and making to buying, set and delivery.

In 1998 it is estimated that $43 billion of business-to-business e-commerce was transacted world-wide, and it is predicted that this will increase to $300 billion by 2002. The value of e-commerce between businesses and consumers was an estimated $7 billion world-wide in 1998, and is expected to grow to perhaps $80 billion in 2002.

Electronic commerce portals provide a single Internet access point for a collection of electronic commerce sites. The portal provider typically hosts the commerce sites and offers merchants tools to build and maintain the sites. The portal is the electronic equivalent of a shopping mall with each commerce site being equivalent to a store.

### SUMMARY OF THE INVENTION

In a first aspect, the invention is an electronic commerce portal for electronic commerce over the World Wide Web, the portal comprising:
a portal web site and a collection of merchant web sites linked to the portal, and merchant tools to build and maintain merchant web sites; wherein the tools include functionality to allow merchants to select products and services to be offered with an associated buyer incentive, and wherein the portal operates to cause the buyer incentives to be displayed on the merchant web site and on a page of the portal web site accord to pre-determined portal rules.

The portal rules may include a maximum number of buyer incentives to be displayed on the portal web site from each merchant at the same time, or a limit to the time for which the same buyer incentive will be displayed on the portal. Such rules are able to promote a stimulating variety of buyer incentives from different merchants to be displayed.

The portal rules may include the specific times for each buyer incentive to be displayed. This allows the targeting of specific groups of people who use the portal at different times.

The portal rules may determine which page of the portal web site the buyer incentive is to be displayed on. This allows the targeting of specific groups of people who view certain pages on the portal. In the case of multiple portals, the rules may determine which portal the buyer incentive is to be displayed on.

The buyer incentives may include special price offers on products or services offered by the merchant web sites. The portal may provide a field in a form for the merchant to indicate whether a particular product or service is a special.

The buyer incentives displayed on the portal site may be hyperlinked to their respective merchant web site. Interested users can then be conveniently re-directed to the merchant web site to purchase the product or service offered through the buyer incentive.

A portal server may host the merchant web sites. Hosting the merchant web sites provides more functionality and control to the portal leading to more effectively displays buyer incentives.

The portal rules may automatically determine the arrangement of the display of buyer incentives on the portal site. For instance, the incentives of merchants of related business types can be displayed together, therefore providing cross-niche marketing opportunities among those merchants' customers.

The portal rules will typically be determined by a portal administrator for each merchant site depending on a licence fee paid by the merchant. The merchant may retain some measure of control of the buyer incentives within boundaries set by the rules.

The merchant tools may be provided to the merchant in an e-commerce management software program. The program may be installed on the merchants' computers or made available to them at a secure download page at the portal site.

The portal may also host web sites for non-commercial groups, such as community and interest groups. Web authoring tools may be provided freely to such groups to build and maintain sites accessible through the portal site. These tools may also be sponsored by merchants and enable the non-commercial groups to modify the screen layout of their web sites according to their taste. These sites should bring increased traffic through the portal, and to the merchant sites. Information about the merchant sites and the buyer incentives at the portal may serve to increase business to the merchant web sites.

The portal may display buyer incentives on the non-commercial web sites. The buyer incentives displayed on a particular non-commercial web site may be related to the content of that site; for instance buyer incentives for sporting goods may be provided on the local tennis club web site. This provides marketing opportunities for merchants to offer buyer incentives to the interest groups.

The portal rules may automatically determine which interest group web site the buyer incentive is to be displayed on. This allows merchants to display buyer incentives to interest groups which axe in their target market.

The portal rules may analyse the content present on the interest group web site to determine whether a buyer incentive is to be displayed on that site. This allows for specific buyer incentives to be displayed, for instance, when special events an published on the interest group web site.

The buyer incentives displayed on the hosed interest group web sites may be linked to the hosed merchant web sites. As a result, interested users can be conveniently re-directed to the merchant web site to purchase the product or service offered through the buyer incentive.

The buyer incentives displayed on the hosted interest group web sites may be displayed in a persistent area. This improves the navigation experience for users. Preferably, the area is displayed statically and updated when the page is refreshed.

The hosted interest group web sites may also include on-line forums and discussion boards. The hosted interest group web sites nay also include local news and weather. These tools for interest group web sites improve the content and functionality of the interest group web sites. The news provided on an interest group web site may be collected from other interest group web sites. The local news may be an aggregation of all the news provided on all the interest group web sites.

In a second aspect, the invention is an e-commerce management she program comprising:
a web site authoring module to enable a merchant to build and modify a merchant web site linked to a page of e portal, where,
the web site authoring module has functionality to enable the merchant to select products or services to be associated with a buyer incentive, and,
the web site author module interacts with the portal to cause the buyer incentive to be displayed on the merchant web site and on one or more pages of the portal according to predetermined portal rules.

The e-commerce management software program may be updated through a connection to a portal server. This allows for convenient upgrading of the e-commerce management software program if an update is required.

The merchants of the hosted merchant web sites maybe merchants of a pre-determined geographic area. Increasing the participation of local merchants encourages cross-niche marketing.

In a third aspect, the invention is a method of operating an electronic Commerce portal over the World Wide Web, the method comprising the steps of:
merchants using merchant tools to build and maintain merchant web sites linked to the portal;
merchants selectin products and services to be offered on the web site with an associated buyer incentive, and
the portal operating to cause the buyer incentives to be displayed on the merchant web site and on a page of the portal web site according to pre-determined portal rules.

The merchant web site may provide a competition where the merchant selects a product to be won, sets a price to determine whether a product has been won and sets a time period for the competition to expire. Customers interested in winning the product register only once to enter the competition, and when the time period has expired, a winner is chosen from the registered customers at random allowing the winner to purchase the product at the price set by the merchant. Advantageously, the merchant has collected a list of customers that were interested in purchasing the product.

The merchant web site may provide an alert on a product page, where if clicked by a customer allows the customer to enter a price they are willing to pay for the product. If the price of the product is equal to or less than the price entered by the customer, the customer is notified by e-mail that their price has been reached. This allows customers to be conveniently informed of products they are interested in when they being axe sold at a price they are willing to pay.

The merchant web site may provide a competition to allow a customer to bid only once on a product and is prevented from seeing bids from other customer. If the customers bid exceeds a reserve price set by the merchant, the customer may purchase the product at the customer's bid price.

Advantageously, the merchant bas collected a list of customers that were interested in purchasing the product.

### BRIEF DESCRIPTION OF DRAWINGS

An example of the invention win now be described with reference to the accompany drawings, in which:—

FIG. 1 is a block diagram of the e-commerce system.

FIG. 2 is a connectivity diagram of th e-commence system.

FIG. 3 is a screen layout diagram of the e-commerce management software program.

FIG. 4 is a screen layout diagram of the main page of the portal.

FIG. 5 is a screen layout diagram of a hosted merchants web site.

FIG. 6 is a screen layout diagram of a hosted interest group web site.

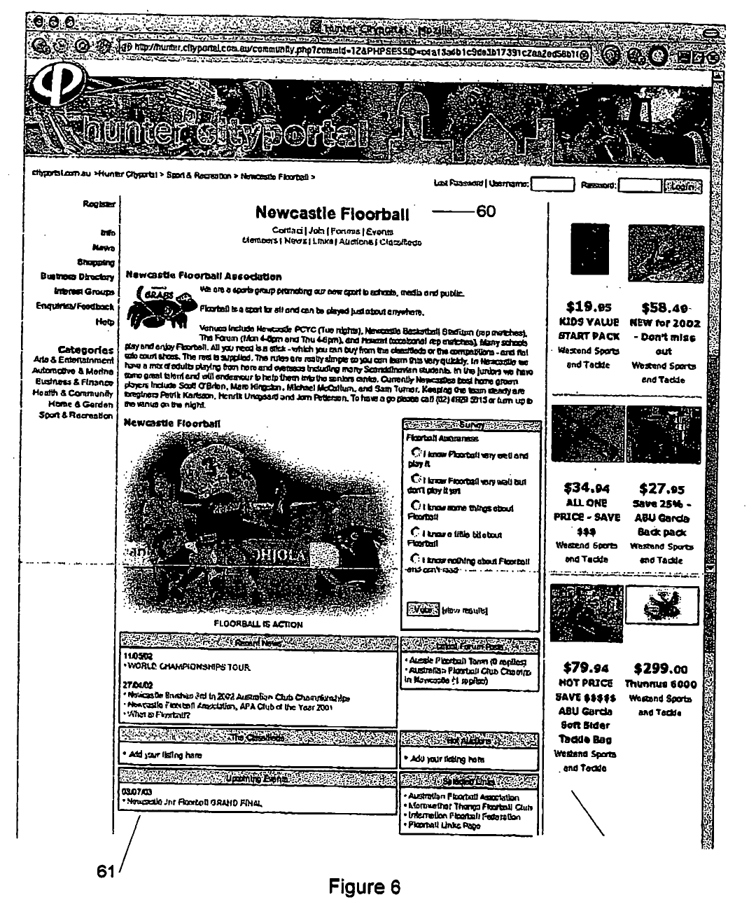

FIG. 7 is an organisational chart of a CityPortal hierarchy.

### DETAILED DESCRIPTION OF THE INVENTION

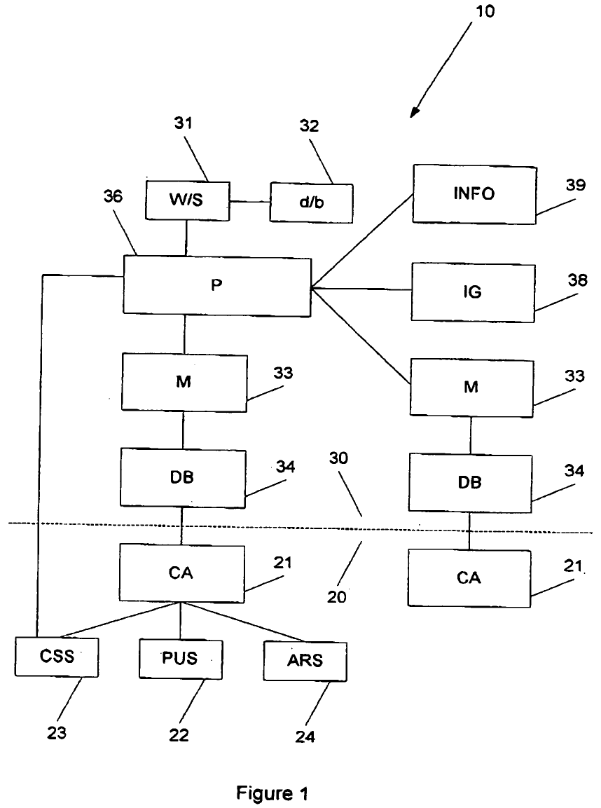

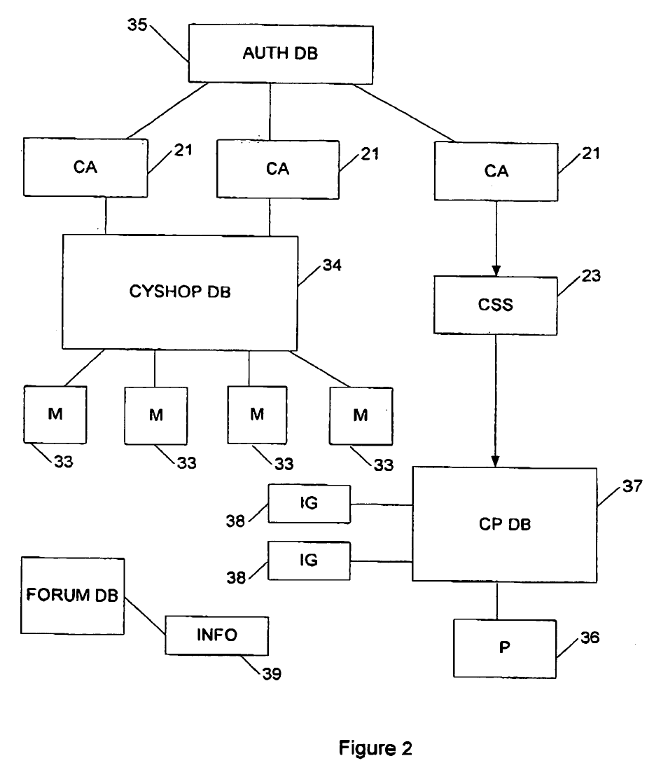

Referring to FIGS. 1 and 2 the e-commence system 10 is a client/server system. On client side 20, a CyShop Online Store Management Application 21 is installed and executed on a merchant's computer. The Management application 21 is written in Java and communicates to web server 31 through the Internet, primarily using the HTTP protocol. The Management application 21 has a Price Update Subsystem 22, CityPortal Special Subsystem 23 and Authentication & Redirector Subsystem 24. When a merchant first loads the Management application 21, the Authentication & Redirector Subsystem 24 validates the merchant when they enter into their Management application 21. The Authentication & Redirector Subsystem 24 verifies their login and password aghast entries stored in Authentication database 35 and issues information needed to connect to their CyShop database 34. The connection information needed includes the database server's IP address which holds the merchant's database 34, database user name and password. The Price Update Subsystem 22 allows a merchant to request a price update from suppliers. It provides automatic price updating and product list importing from suppliers and allows merchants to avoid having to manually enter product detailers from products supplied by the suppliers. A series of filters are used to be import price lists from various suppliers which may be stored in the supplier's own format Changes that are made to product details, including prices in the Management application 21 are instantly reflected on the web site 33 since both the Movement application 21 and web site 33 read and write to the same database 32.

On server side 30, web server 31 is connected to the Internet and has a PostgreSQL database 32, but any database can be used such as Oracle gi or Microsoft SQL Server. Each CityPortal 36 is served through web server 31 and can be targeted or created for certain geographic regions, for example, the Hunter Region in New South Wales, Australia The CityPortal for the Hunter Region is aptly need Hunter CityPortal and has a convenient URL: http://hunter.cityportal.com.au. Each CityPortal 36 has a CityPortal database 37. The web server 31 also hosts web sites of each merchant 33 which have been created using the CyShop Online Store management Application 21. Alternatively, each merchant web site 33 is hosted on its own web server and connected to a selected CityPortal 36. Each of the CyShop Online Store web sites 33 has an associated merchant database 34, which stores information to be displayed on the web site 33. The CityPortal databases 37, merchant databases 34 and the authentication database 35 can be stored in a single database server. Alternatively, they may be part of a load balanced database server system, or even spread over a multitude of database servers.

The CityPortal Special SubSystem 23 is a collection of scripts and database tables that facilitate the posting of specials from a muerchant's CyShop web site 33 to a CityPortal web site 36. The scripts are written in Practical Expression and Report Language (PERL) and PHP: Hypertext Preprocessor (PHP). A special on a product or service means that the merchant has decided to sell the product or service at a discounted price when compared to normal res prices. There is both a “push” and a “pull” mechanism to facilitate the posting of specials.

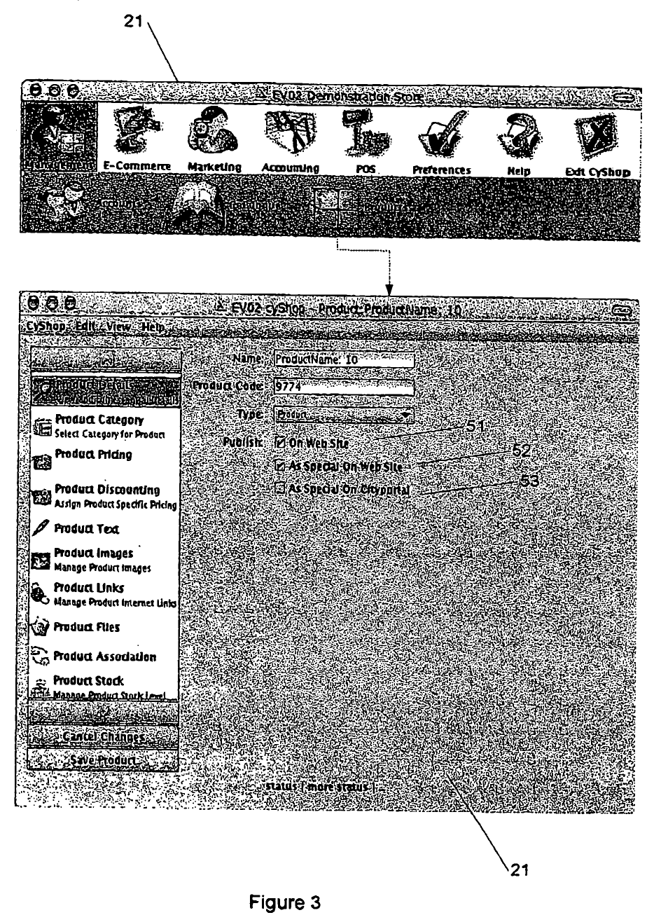

The “push” mechanism will generally be described with reference to FIG. 3. A merchant use the CyShop Online Store Management Application 21 can set a product to “Publish” 51 on the merchant's web site 33, be a “Special” only on the merchant's web site 33, or be a “CityPortal Special” 53. When a merchant set the product as an active “CityPortal Special” 53, an (eXtensible Markup Language) XML message is posted via HTTP to a PHP script on web server 31. The PHP script inserts the XML message into a table of database 32. A PERL script as a daemon periodically polls this table and extracts the data from the XML message. The daemon also checks with the merchant's database 34 which CityPortal web site 36 that merchant's specials are to be posted on, for example, Hunter CityPortal, and builds a new XML message with the information about the special, and transmits this information to a PHP script on the corresponding CityPortal web site 36. This PHP script extracts the data from the XML message and adds the special to the CityPortal database 37 “specials” table.

An alternative backup system using a “pull” mechanism is provided where another PERL script, periodically (at midnight every day) empties all the CityPortal “specials” tables from the CityPortal databases 37 and then re-populates the CityPortal “specials” tables from all the specials in all the merchants' databases 34. This synchronises all the merchant databases 34 with the CityPortal databases 37, in the event of en error with the “push” mechanism, or when a special has been manually deleted from a merchant's database 34, The Management application 21 uses Java Database Connectivity (JDBC) to communicate with the merchant's database 34.

There are two fields in the merchants database 34 which determine specials. Both these fields are integer fields. One field determines whether a product is a special on the merchants own CyShop web site 33, and the other field determines whether the product is posted on a CityPortal web site 30, for example, Hunter CityPortal. The merchant's database 34 is updated when the product screen is closed, if a change has been made.

The product information that is shown on a CityPortal web site 36 is the same as the information stored in the product table of the merchant's database 34, by mirroring the duct table on the CityPortal web site 36 using the “push” mechanism described above.

Other marketing tools are provided by the Management application 21 such as “Lucky Web Prizes”, “Pick your Price” and “Buyer's Alert”. These tools are integrated into the Management application 21 and also have elements on the CyShop web sites 33.

On the merchant's web site 33 at product information pages, there is a “Buyer's Alert” hyperlink. If a customer clicks the hyperlink, they can register their customer identification code with the production identification code and also a price. If the price of the product reaches or falls below the price registered by the customer, an e-mail is sent out to the customer to notify them of that fact In the preferred embodiment, “Buyer's Alert” e-mails are sent out, if required, by the Management application 21 when a product's price is charged.

A “lucky web prize” is similar to a raffle, but differing in that the prize is sold to the winner for a reduced price instead of being awarded free. In a typical scenario, a merchant chooses a product to be the “lucky web prize” and sets a winning price and a time period until the offer expires. The “lucky web prize” offer is displayed on the merchant's web site 33. Customers register for a chance to win the “lucky web prize”, but only once if they are interested in winning the product. When the time period expires, a winner is chosen at random from the customers who have registered, and can buy the product at the winning price. The advantage for the merchant is that they now possess a list of customers who were interested in the product.

A “pick your price” competition is similar to an auction, where customers cannot see each other's bids, and can only bid once for a product. In a typical scenario, the merchant selects a product for a “pick your price” competition end sets a reserve price. The “pick your price” competition is displayed on the merchant's web site 33, and interested customers place a single bid for the product If a customer's bid is above the reserve price, the customer can buy the product at that price. Similar to the “lucky web prize”, the merchant now possesses a list of customers who were interested in the product.

The e-commerce system 10 uses cross niche marketing as one of its main marketing tools. Cross niching involves defining a segment of the population by demographics and finding a commonality between two or more subdivisions of the customer base. For example, different merchants in a local community. The display of specials from various merchants on the main page 40 of the portal is one example of cross niche marketing. The system 10 also uses passive marketing through the use of forums, interest groups and other non-commercial mans to generate user traffic to the portal. The portal provides local communities with the tools and means to create an on-line community catering for all interest groups without prejudice towards any demographics of groups in the community. This allows the local communities to create user-driven content and thus increase locally based Internet traffic. While the portal provides a medium for community-based interest groups. local merchants are also catered for by using the key solution of the CyShop Online Store Management Application 21. that is, a complete system designed for a specific application which is pre-assembled and delivered to the merchant, ready to operate.

The portal uses an Application Service Provider (ASP) model by hosting the menxhemt's web sites, providing security, back up and e-commerce payment services. This model permits a merchant to have a complete electronic commerce solution at a fraction of the cost when compared to constructing one themselves.

The hosting of interest group web sites 38 such as sporting clubs, church groups or any other community group, is a form of passive marketing. Hosting these web sites 38 draw interest group participants to the portal. A forum, bulletin board or news feed can be constructed on the interest group web site 38 to allow participants to communicate and share information, such as future meetings and events. When these interest group web sites 38 are displayed to a user, a persistent area of specials 62 offered by merchants which have their web site 33 hosted by the portal is also displayed. This area of specials 62 can be a frame or pane or a window of a web page. This area of specials 62 can have a smaller number of specials than the main page 40 on the portal. In the preferred embodiment, the display of the area of specials 62 is static and changes content when the page is refreshed. The specials displayed in this area 2 can also be targeted according to the interest group. That is, if the interest group is a local sports club, then specials from the local sports store merchant will be displayed or be allocated a higher probability of being displayed. It is envisaged that while selecting products or services as specials, merchants can also select specific interest group web sites 38 to have those specials displayed in. It is also possible that when a specific interest group is holding an event for example, the local car club is holding a rally, an automobile accessory merchant can be notified via e-mail that this event is to occur. If desired the merchant then can increase the number of products or services on special or change which products or services to be on special. This means that the selection of specials by a merchant can be dependent on the content of the interest group web site 38. These rules or schemes to determine when and which web sits to display a special on is pre-determined according to the merchant or the administrators of the portal. The dependence and relationship to the content of the interest group web sites 38 encourages the specials offered by a merchant to be changed more frequently. Frequent changes in content on both the interest group web sites 38 and merchant web sites 33, generally increase user traffic, as users will tend to visit the portal more often knowing that the content is ever changing.

Another form of passive marketing can be done by providing general information web sites 39, such as a local community bulletin board. Localised news and weather specific to the geographic area relating the portal can draw traffic from the local residents and merchants of the community.

It is also envisaged that cross marketing between different CityPortals can occur. That is, if a merchant does not exist in the Hunter CityPortal, a customer can be directed to the closest CityPortal which has such a merchant.

The relationship between niche marketing and passive marketing is facilitated by the portal prodding on-line community tools for groups of people to create web sites for their specific interest group. These groups ar self-organised into target markets which allow merchants to market directly through the use of specials and other marketing tools. Merchants can efficiently market their products to the groups they have identified as potential customers because visitors to a particular interest group web site generally indicate a common interest, for example, cars or fishing if the interest group web site is for can or fishing. User traffic is brought to the portal not only by the web sites of the merchants but also because of the interest group web sites. Cross linking between these web sites and lining to other CityPortals can increase sales opportunities for merchants with web sites hosted by the portal because of the increased traffic and the nature of the relationship between the merchant and the interest group.

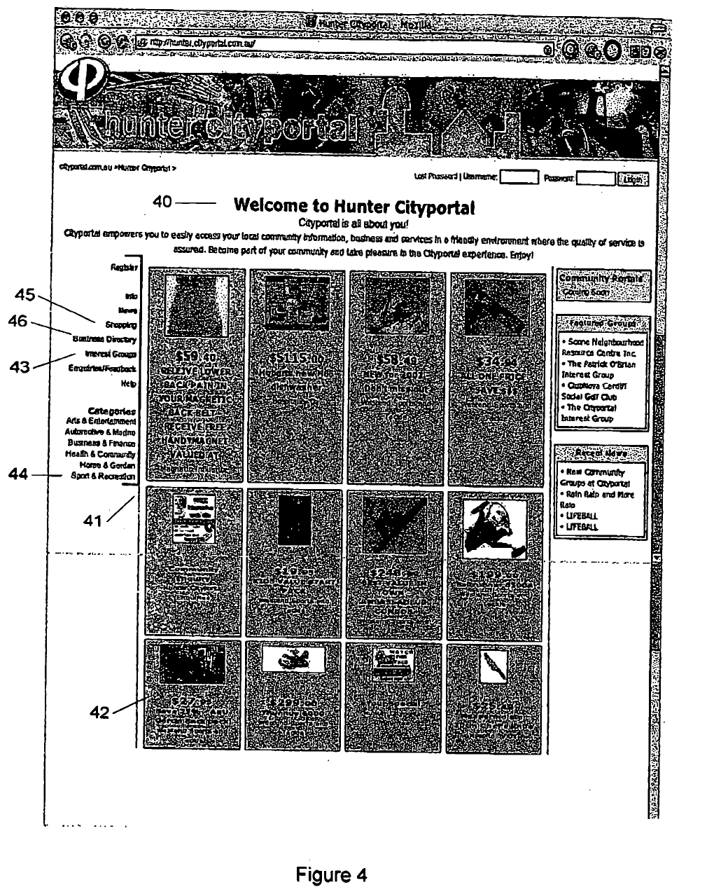

Referring to FIG. 4, specials 40 axe presented on the main page of the CityPortal web site 36. There is a persistent navigation area 41 displayed to allow users to navigate in the portal. The portal is divided into information groups such as News, Shopping, Classifieds, Auctions, Services, Forums, Personals, Interest Groups 38. Also in the navigation ama 41, the hosted web sites are divided into categories, for example. Arts & Cult ire, Community, Computers, Home & Garden, Sports and Tourism. This type of navigation is consistent with the facilitation of cross niche marketing as described, because in both the Shopping information group 45 and also in any of the categories, the hosted web sites of merchant are listed. This provides a convenient method for users of the portal to navigate quickly and efficiently to the information they require.

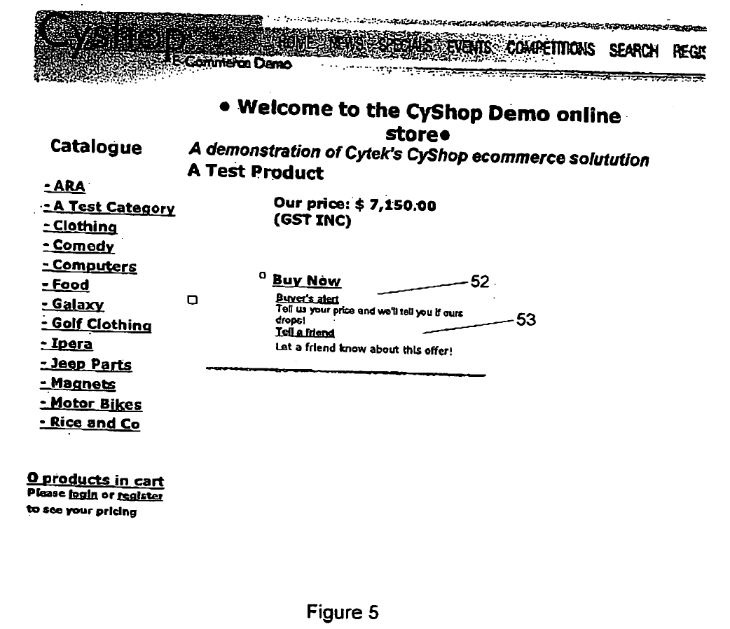

In a typical scenario, if a user decides they are interested in a product or service on presented on the mal page 40 of the portal as a special, they can click the image or description of the product 42, and are redirected to the hosted web site of the merchant. Turning to FIG. 5, the user is then re-directed to the merchant's web site where a more detailed description of the product is presented and other marketing tools can be used, such as “Buyer's Alert” 52 or “Tell A Friend” 53. In this scenario, tragic to the merchant's web site has occurred as a result of the special being displayed on the main page 40 of the portal. The aggregation of specials offered by merchants being displayed on the main page 40 of the portal amplifies the potential for a sale to be made from a casual user.

Referring to FIG. 5, a user who is also a basketball fan of the local team wants to find out the venue for the next game. In this different scenario, from the main page 40 of the portal, the user can either navigate via Interest Groups 43 or Sports category 44. This rejects the fan to the “Newcastle Basketball” interest group web site 60, where information about the team is provided. Pictures from past games, news on the team, forums and surveys are provided on this web site 60. The fan locates the link to the “Upcoming Events” 61, and there is able to find the next venue. In every hosted non-merchant web site, such as interest groups or general community information, a persistent area of specials 62 is displayed on the right side of each web site. In the preferred embodiment, the display of the area of specials 62 is static and changes content when the page is refreshed. This is consistent with the facilitation of cross niche marketing as described. The specials in the area 62 can be displayed from merchants who sell products or services relating to basketball or sports in general. If a basketball is on special from the local sports store, the fan can click on the special in the area 62 and be re-directed to the hosted web site of the sports store.

The CyShop Online Store Management Application 21 can be updated via the Internet automatically upon loading. This means that distribution of newer versions of the software is made easier. For example, if taxation laws are changed which affect the merchant, their Management application 21 can be provided an update on a centralised server which will be automatically downloaded by the merchants the next time they use the Management application 21. Alternatively, frequent distribution of Management Application 21 upgrades can be avoided since changes in laws and other data can be done on a central database which the Management Application 21 points to. For example, if the taxation laws are stored in a database, changes to the tax rules are independent of changes to the Management Application 21. The CyShop Online Store Management Application 21 also has an interface to transmit sales and product data to accounting software applications such as MYOB.

CyShop Online Store Web sites 33 can be generated quickly using templates so that merchant's can roll out their e-commerce in a short amount of time. Templates can provide a front-end for different types of businesses, for example, sports stores, hardware stores or consumer electrical stores. Some templates are included in the Management Application 21, while others can be downloaded from the Internet.

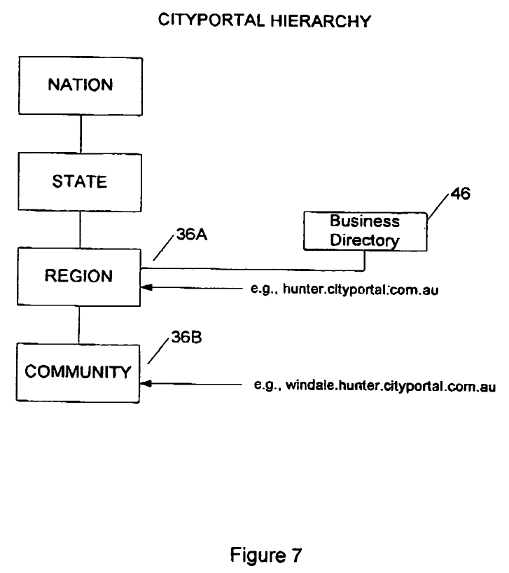

Referring to FIG. 7, a merchants CyShop web site 33 exists in a two level hierarchy: Regional CityPortals 36A and Community CityPortals 36B. Regional CityPortals 36A include a Community Portal list. The list of Community Portals links to individual Community CityPortals 36B. Selecting an item on the Community Portal list directs a user to a Community CityPortal web page. Community CityPortals 36B include a Localities list. Each Locality represents a suburb category. Locality categories are similar to existing Categories. Selecting an item on the Localities list directs a user to Category List displaying online stores, services and interest groups in that Locality.

A Community CityPortal 36B allows users to access Specials, Online Stores, Services, Business Directory 46 listings and Interest Groups that exist in the community.

A Regional CityPortal 36A allows Users to access Specials, Online Stores, Services, Business Directory 46 listings and Interest Groups that exist in the region. This includes everything that exists on the Community CityPortals that belong to the Regional CityPortal 36A. The Business Directory 46 provides business contact details in a directory form and also provides SMS information services. The Directory 46 can be browsed through a navigable multilevel category structure, and can also be searched using key words. On CityPortals 36, the Services link includes Service Providers as well as Shopping.

Auctions, classifieds, personals and forms exist on a Regional CityPortal 36A level. When a user accesses auctions, classifieds, personals or forums through a Community CityPortal 36B, they are able to access the entire region.

On the main page of a Regional CityPortal 36A, specials are selected randomly from the entire region pool of specials, which includes all specials from communities in the region. Regional CityPortal 36A category specials are selected in order of Region wide category, then Region wide.

On the main page of a Community CityPortal 36B, specials are selected in order of Community wide, then Region wide. Community CityPortal 36B category specials are selected in order of Community category, Region wide category, Community wide, then Region wide.

Although the invention has been described with reference to web sites on the Internet, it is possible that the use of other protocols such as Wireless Application Protocol (WAP), can allow the invention to be used on mobile devices and transmitted through other electronic media.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An electronic commerce portal for electronic commerce over the World Wide Web, the portal comprising:
a portal web site and a collection of merchant web sites linked to the portal, and merchant tools to build and maintain merchant web sites;
wherein the tools include functionality to allow merchants to select products and services to be offered with an associated buyer incentive, and wherein the portal operates to cause the buyer incentives to be displayed on the merchant web site and on a page of the portal web according to pre-determined portal rules.

2. The electronic commerce portal according to claim 1, wherein the portal rules include a maximum number of buyer incentives to be displayed on the portal web site from each merchant at the same time.

3. The electronic commerce portal according to claim 1, wherein the portal rules include a limit to the time for which the same buyer incentive will be displayed on the portal.

4. The electronic commerce portal according to claim 1, wherein the portal rules include the specific times for each buyer incentive to be displayed.

5. The electronic commerce portal according to claim 1, wherein the portal rules determine which page of the portal web site the buyer incentive is to be displayed on.

6. The electronic commerce portal according to claim 1, wherein the buyer incentives include special price offers on products or services offered by the merchant web sites.

7. The electronic commerce portal according to claim 6, further comprising a field in a form for the merchant to indicate whether a particular product or service has a special price offer.

8. The electronic commerce portal according to claim 1, wherein the buyer incentives displayed on the portal site are hyperlinked to their respective merchant web site.

9. The electronic commerce portal according to claim 1, further comprising a portal server to host the merchant web sites.

10. The electronic commerce portal according to claim 1, wherein the portal rules automatically determine the arrangement of the display of buyer incentives on the portal site.

11. The electronic commerce portal according to claim 10, wherein the buyer incentives of merchants of related business types are displayed together.

12. The electronic commerce portal according to claim 1, further comprising a control means to enable merchants to control their buyer incentives within boundaries set by the portal rules.

13. The electronic commerce portal according to claim 1, wherein the merchant tools are provided to the merchant in an e-commerce management software program.

14. The electronic commerce portal according to claim 13, wherein the e-commerce management software program is installed on the merchants' computers.

15. The electronic commerce portal according to claim 13, wherein the e-commerce management software program is available to merchants at a secure download page at the portal web site.

16. The electronic commerce portal according to any one of the preceding claims, wherein the portal hosts web sites for non-commercial groups.

17. The electronic commerce portal according to claim 16, wherein the non-commercial groups include community and interest groups.

18. The electronic commerce portal according to claim 16, wherein the web authoring tools are provided freely to the non-commercial groups to build and maintain sites accessible through the portal site.

19. The electronic commerce portal according to claim 18, wherein the web authoring tools are sponsored by merchants to enable the non-commercial groups to modify the screen layout of their web sites.

20. The electronic commerce portal according to any one of claim 16, wherein the portal displays buyer incentives on the non-commercial web sites.

21. The electronic commerce portal according to claim 20, wherein the buyer incentives displayed on a particular non-commercial web site are related to the content of that site.

22. The electronic commerce portal according to claim 16, wherein the portal rules automatically determine which interest group web site the buyer incentive is to be displayed on.

23. The electronic commerce portal according to claim 16, wherein the portal rules analyse the content present on the interest group web site to determine whether a buyer incentive is to be displayed on that site.

24. The electronic commerce portal according to claim 16, wherein the buyer incentives displayed on the hosted interest group web sites are linked to the hosted merchant web sites.

25. The electronic commerce portal according to claim 16, wherein the buyer incentives displayed on the hosted interest group web sites are displayed in a persistent area

26. The electronic commerce portal according to claim 25, wherein the persistent area is displayed statically and updated when the page is refreshed.

27. The electronic commerce portal according to claims 16, wherein the hosted interest group web sites include on-line forums and discussion boards.

28. The electronic commerce portal according to claims 16, wherein the hosted interest group web sites include local news and weather.

29. The electronic commerce portal according to claim 28, wherein the news provided on an interest group web site is collected from other interest group web sites.

30. The electronic commerce portal according to claim 29, wherein local news on the portal web site is an aggregation of all the news provided on all the interest group web sites.

31. The electronic commerce portal according to claim 1 wherein the merchant web sites provide a competition where the merchant selects a product to be won, sets a price to determine whether a product has been won and sets a time period for the competition to expire.

32. The electronic commerce portal according to claim 31, wherein the merchant web sites further comprise a collection means to collect a list of customers that were interested in purchasing the product.

33. The electronic commerce portal according to claim 31, wherein the merchant web site provide an alert on a product page, where if clicked by a customer allows the customer to enter a price they are wiling to pay for the product.

34. The electronic commerce portal according to claim 33, wherein the merchant web site includes a notification means to notify a customer their price has been reached, if the price of the product is equal to or less than the price entered by the customer.

35. The electronic commerce portal according to claim 34, wherein the customer is notified by e-mail or an SMS message.

36. The electronic commerce portal according to claim 1, wherein a merchant web site includes a competition to allow a customer to bid only once on a product.

37. The electronic commerce portal according to claim 36, wherein the merchant web site prevents customers from seeing bids from other customers in the competition.

38. The electronic commerce portal according to claim 36, wherein the merchant web site include purchasing means for a customer to purchase the product at the customer's bid price, if the customer's bid exceeds a reserve price set by the merchant in the competition.

39. An e-commerce management software program comprising:
a web site authoring module to enable a merchant to build and modify a merchant web site linked to a page of a portal, where,
the web site authoring module has functionality to enable the merchant to select products or services to be associated with a buyer incentive, and
the web site authoring module interacts with the portal to caused the buyer incentive to e displayed on the merchant web site and on one or more pages of the portal according to pre-determined portal rules.

40. An e-commerce management software program according to claim 39, further comprising updating means for updating the e-commerce management software program through a connection to a portal server.

41. The e-commerce management software program according to claim 39, wherein the merchants of the hosted merchant web sites are merchants of a pre-determined geographic area.

42. A method of operating an electronic commerce portal over the World Wide Web, the method comprising the steps of:
merchants using merchant tools to build and maintain merchant web sites linked to the portal;
merchants selecting products and services to be offered on the web site with an associated buyer incentives, and
the portal operating to cause the buyer incentives to be displayed on the merchant web site and on a page of the portal web site according to pre-determined portal rules.

43. A collection of interlinked electronic commerce portals, the electronic commerce portals enabling electronic commerce over the World Wide Web, each portal comprising:
a portal web site and a collection of merchant web sites linked to the portal, and merchant tools to build and maintain merchant web sites;
wherein the tools include functionality to allow merchants to select products and services to be offered with an associated buyer incentive, and wherein the portal operates to cause the buyer incentives to be displayed on the merchant web site and on a page of the portal web site according to pre-determined portal rules,
where, the portal rules determine which portal the buyer incentive is to be displayed on.

44. The collection of interlinked electronic commerce portals according to claim 43, further comprising a portal hierarchy, wherein each portal exists in at least one level of the hierarchy.

45. The collection of interlinked electronic commerce portals according to claim 44, wherein the levels of the hierarchy include national, state, regional or community.

46. The collection of interlinked electronic commerce portals according to claim 44, further comprising a business directory to provide business contact details and/or SMS information services to users.

47. The collection of interlinked electronic commerce portals according to claim 45, wherein the business directory is in the form of a navigable multilevel category structure.
